(19) United States
(12) Patent Application Publication
(10) Pub. No.: US 2023/0314577 A1
(43) Pub. Date: Oct. 5, 2023

(54) MEASURING SYSTEM FOR A CONSTRUCTION AND WORK MACHINE

(71) Applicant: MOBA Mobile Automation AG, Limburg (DE)

(72) Inventor: Volker HARMS, Limburg (DE)

(21) Appl. No.: 18/191,757

(22) Filed: Mar. 28, 2023

(30) Foreign Application Priority Data
Mar. 29, 2022 (EP) EP22164977.5

(51) Int. Cl. G01S 7/497; G01S 17/894

(52) U.S. Cl. CPC G01S 7/497; G01S 17/894

(57) ABSTRACT

A calibration system for calibrating a component of a construction machine, in particular an excavator, a bulldozer, a grader, a drill rig, a pile driver or a diaphragm wall cutter, the component having at least one degree of freedom, having: a mobile device having a LiDAR sensor, the LiDAR sensor being configured to detect a plurality of measurement points of the component and/or the construction machine to determine position information for the plurality of measurement points of the component and/or the construction machine; a processor configured to determine a 3D model of the component and/or the construction machine based on the position information for the plurality of measurement points.

### CROSS-REFERENCE TO RELATED APPLICATION

This application claims priority from European Application No. EP22164977.5, which was filed on Mar. 29, 2022, and is incorporated herein by reference in its entirety.

### FIELD OF THE INVENTION

Embodiments of the present invention relate to a calibration system for calibrating a component of a construction machine. Further embodiments relate to a corresponding method and computer program. In general, embodiments of the invention can be found in the field of mobile construction and work machines, in particular construction machines for working on and removing soil, rock or rock or soil material. Examples include excavators, bulldozers, graders, drilling equipment or drilling machines, piling apparatus or diaphragm wall cutters. Particular embodiments relate to a measuring system for measuring or calibrating the geometry of the construction machine and work machine.

### BACKGROUND OF THE INVENTION

Nowadays, drivers of earth-moving machines such as excavators are increasingly using so-called assistance systems or control systems in order to be able to precisely carry out the required operations during construction work. The assistance systems or control systems support and relieve an excavator operator, for example, in work to be done such as excavation, installation or depositing earth, gravel, sand or other construction material. Assistance systems or control systems (so-called excavator controls) also support and relieve the excavator operator when working under difficult visibility conditions, such as when building slopes or working under water. The information regarding the exact position of the excavator and the excavator scoop can be displayed graphically to the machine operator on the assistance system or control system so that the operator can use the information while controlling the machine.

In order for the work steps to be carried out precisely, it must be possible to position the excavator tools very accurately. For this purpose, the excavator must be measured or calibrated accordingly before work begins, i.e. various dimensions, distances and positions of the excavator scoop, boom, dipper arm, rotary axes, etc. must be determined exactly and entered into the excavator control system.

Assistance systems for construction and work machines are known, such as the X-Site excavator control system, which measures the depth, height and inclination of the excavator scoop by means of various sensors and displays the excavator scoop position graphically and numerically on a display and control unit in the excavator cab. Another well-known assistance system for construction and work machines is the iDig excavator control system.

With regard to the calibration of the geometry of the machine, EP 3 730 702 A1 by Novatron, Finland, is known from the conventional technology, which describes a measuring arrangement for, for example, earth-moving machines or lifting machines, wherein the measuring arrangement can be used for individual calibration of each machine.

Furthermore, EP 3 613 905 A1 by Bridgin, France, should be mentioned, which describes a leveling guidance system for earth excavating machines, such as excavators. The guidance system includes an angular position detection device, a laser detection device, and a control device.

Of disadvantage with the known systems is that measuring or calibrating the geometry of the machine is very complex and very time-consuming, and in addition to a plumb and a tape measure, other special aids are usually required, such as one or more total stations. Even with the already mentioned iDig excavator system, which has an automatic measuring mode, the calibration is very time-consuming. Therefore, there is need for an improved approach.

### SUMMARY

According to an embodiment, a calibration system for calibrating a component of a construction machine, in particular an excavator, a bulldozer, a grader, a drill rig, a pile driver or a diaphragm wall cutter, wherein the component has at least one degree of freedom, may have: a mobile device having a LiDAR sensor, wherein the LiDAR sensor is configured to detect a plurality of measurement points of the component and/or the construction machine to determine position information for the plurality of measurement points of the component and/or the construction machine; a processor configured to determine a 3D model of the component and/or the construction machine based on the position information for the plurality of measurement points.

Another embodiment may have a construction machine, in particular an excavator, bulldozer, grader, drilling rig, pile driver or diaphragm wall cutter, having an inventive calibration system as mentioned before, and a machine controller.

According to another embodiment, a method for calibrating a component of a construction machine, in particular an excavator, a bulldozer, a grader, a drill rig, a pile driver or a diaphragm wall cutter, wherein the component has at least one degree of freedom, may have the steps of: detecting, by a LiDAR sensor of a mobile component, a plurality of measurement points of the component and/or the construction machine to determine position information for the plurality of measurement points of the component and/or the construction machine; and determining a 3D model of the component and/or the construction machine based on the position information for the plurality of measurement points.

Another embodiment may have a non-transitory digital storage medium having a computer program stored thereon to perform a method for calibrating a component of a construction machine, in particular an excavator, a bulldozer, a grader, a drill rig, a pile driver or a diaphragm wall cutter, wherein the component has at least one degree of freedom, having the step of: detecting, by a LiDAR sensor of a mobile component, a plurality of measurement points of the component and/or the construction machine to determine position information for the plurality of measurement points of the component and/or the construction machine; determining a 3D model of the component and/or the construction machine based on the position information for the plurality of measurement points, when said computer program is run by a computer.

Embodiments of the present invention provide a calibration system for calibrating a component, such as an excavator arm segment or scoop, of a construction machine, particularly an excavator, bulldozer, grader, drill apparatus, piling apparatus (pile driver) or diaphragm wall cutter. The component comprises at least one degree of freedom. In the simplest implementation, the calibration system comprises a mobile device, such as a smart device, smartphone, or tablet computer, and a processor. The mobile device comprises a LiDAR sensor. The LiDAR sensor is configured to detect a plurality of measurement points of the component, such as joint points or characteristic points and/or measurement points of the construction machine, to determine position information for the plurality of measurement points of the component and/or the construction machine. The processor is configured to determine a 3D model of the component and/or the construction machine based on the position information for the plurality of measurement points.

According to embodiments, the position information may include distance information (relative to the LiDAR sensor) or 3D position information.

Embodiments of the present invention are based on the fact that a construction machine can be measured or calibrated by means of a commercially available smartphone with a camera with LiDAR support (LiDAR sensor system) by processing the recorded data using a corresponding software app. The processed data can then be made available, for example, to an assistance system (control system) for operating the controller of the construction machine (for example, an excavator controller).

The background is that mobile devices such as smartphones are now equipped with integrated LiDAR sensor systems. Examples of this are Apple iPhone 12 Pro, iPhone 13 Pro, iPad Pro. The advantage is that the calibration can be done by a machine operator, which means that no separate or trained measurer is needed. This leads to considerable time and cost savings, as no complex setup or installation of special measuring equipment such as total stations or similar is entailed.

LiDAR (light detection and ranging) is a method of distance measurement using time-of-flight measurement. For example, laser beams or light beams in general are emitted and the reflection is recorded. This means that if a laser beam hits an object and is reflected, the scanner calculates the distance to the sensor or iPhone or iPad based on the travel time of the reflected light. Since the LiDAR scanner emits the light in a point grid, the sensor detects several object parts at once and creates a 3D model with depth information in real time.

According to embodiments, at least two measuring points are recorded per component. The component can, for example, be a segment of a construction machine, e.g. an excavator. If, for example, two points of the segment are detected, the orientation of the segment in space can be determined on the basis of the detected positions of the two measuring points. Thus, a 3D position per measuring point in space can then be derived, wherein the plurality of measuring points or the point cloud detected by the LiDAR system can be used to determine the 3D model. According to embodiments, the determination is carried out in two coordinates visually, e.g. with the camera integrated in the mobile device, wherein corresponding depth information per 2D position are determined by means of the time-of-flight measurement and extended to a 3D position. This means that all essential information are obtained by taking a side view of the machine/excavator with the smartphone (camera and LiDAR sensor). This results in three-dimensional position information in a coordinate system defined by the LiDAR sensor. According to embodiments, the LiDAR sensor is configured to detect the measurement points in several orientations of the LiDAR sensor relative to the component and/or construction machine. This is advantageous, for example, when the construction machine is too large, so that the entire construction machine or all components of the construction machine can be captured in one recording or can be captured by means of one measurement. In this case, a human-machine interface of the mobile device can advantageously provide the user with an indication of how the LiDAR sensor is to be oriented.

The recorded data of the LiDAR sensor form a point cloud, even if several recordings were carried out. With regard to the recorded point cloud, it should be noted that the operator can use the app to select any point on the machine and determine the distance and position values relevant for the excavator control and mark them in the 3D model. According to further embodiments, detection of the measurement points can take place in one positioning of the component or construction machine, or alternatively in several positionings. Preferably, a plurality of components, each of which may have its own degree of freedom and also a plurality of degrees of freedom, are detected during the measurement. Examples of components are an excavator scoop, an excavator arm segment, a further segment of excavator arm. According to embodiments, the processor is configured to determine the 3D model for the plurality of components. Here, it may be advantageous if the joints are recognized so that the degrees of freedom per component are determined.

According to embodiments, for example, one or more measurement points can be defined or selected or marked by means of a human-machine interface. The user can thus mark the joint as a measuring point, for example.

The LiDAR sensor is, for example, the camera of the mobile device. All in all, the LiDAR sensor is part of a LiDAR scanner which can also emit light or laser, for example. According to embodiments, the LiDAR scanner is configured to emit light to a point grid correspondingly. This light is used for distance measurement (to generate the depth information), based on a time-of-flight measurement of the light reflection.

According to further embodiments, it would be conceivable for certain measuring points to be marked or colored or raised (e.g. curved upwards). In this respect, if applicable, marks or labels (colored and raised) attached to the machine are suitable to support the recognition during an automatic detection of the relevant measuring points and entailed dimensions. For example, specific points of the component and/or the construction machine can be used as measuring points. Specific points are, for example, one or more of the following:
joint
virtual pivot
fixed point
contact point of the tool.

According to embodiments, the calibration system has a wireless interface for wireless communication with a machine controller. Thus, it is advantageously possible to easily allow data transmission of the determined data as well as the determined distances/positions from the smartphone to the excavator control. The fact that no manual transfer takes place considerably simplifies the installation (calibration) and avoids errors that can occur (as is quite common in the state of the art) when manually typing the values into the excavator control. At this point, it should be noted that the wireless data transmission of the determined data as well as the determined distances/positions from the smartphone directly to the assistance system (assistance system of the excavator system or excavator control) can take place via WLAN or Bluetooth, for example. Alternatively, the wireless data transmission of the determined data and the determined distances/positions from the smartphone to the assistance system (excavator system, excavator control) can take place via network (cloud service, via Internet connection).

According to embodiments, the calibration system comprises a machine controller and/or a machine display, or vice versa, the calibration system is part of the machine controller. For example, the excavator controller (assistance system, control system) may comprise a display and operating unit including, for example, a controller, a memory, a display, an input unit (keyboard or touch operation) and communication interfaces (for direct connection to the smartphone and/or for cloud services, via Internet connection). According to further embodiments, the excavator control system (assistance system, control system) is in constant contact with the smartphone app (constantly exchanges data) during the calibration process and provides the smartphone user with information on which data (reference points) should (must) still be recorded and whether the data situation is sufficient (sufficient data or reference points available). Regarding cloud services, it should be noted that they can also be used as follows: Data storage on a remotely located system server, with reference to the respective measured machine. The data can be accessed from different sides, i.e. from the excavator system on the machine, from the smartphone of the operator or from somewhere else. According to embodiments, the machine display is configured to calculate and/or display position and/or positionings of the components based on one or more sensor data for monitoring one or more degrees of freedom, taking into account the 3D model. Here, the machine controller can, for example, calculate the position/positioning of the component.

Another embodiment relates to a construction machine, in particular an excavator, bulldozer, grader, drilling apparatus, piling apparatus (pile driving) or a diaphragm wall cutter with a calibration system as explained above. The construction machine may further comprise a machine controller. In this respect, the teaching described herein is applicable to various types of excavators, sizes of excavators, i.e. regardless of machines and machine sizes. This means that embodiments are applied to other machines equipped with a 3D positioning and control system, and improve the calibration process before starting work. Other examples of machines include drilling apparatus (drilling machines for blast hole drilling), graders, bulldozers, or pile apparatus (pile drivers or piling devices for compacting soil or driving piles or pile pipes) or diaphragm wall cutters.

Further embodiments relate to a method for calibrating a component of a construction machine, comprising the following steps:
detecting, by means of a LiDAR sensor, a plurality of measurement points of the component and/or the construction machine to determine position information for the plurality of measurement points of the component and/or the construction machine;
determining a 3D model of the component and/or the construction machine based on the position information for the plurality of measurement points.

According to embodiments, the method may further comprise the step of recording the component and/or the construction machine by means of a camera of the mobile device, e.g. a camera of the smartphone. According to a further embodiment, the method comprises the step of calculating and/or displaying a position and/or positioning of the component based on one or more sensor data for monitoring one or more degrees of freedom while considering the 3D model.

At this point, it should be noted that another embodiment refers to a computer program having a source code performing the method just explained when the source code runs on a processor. For example, the computer program may be performed by means of an app. The installed (3D scanner) app with the mobile device (smartphone) allows the entire machine to be calibrated. The 3D scanner app (for example from Laan Labs) detects depth information of the object via LiDAR and creates a 3D model of the machine from the recorded points, which can be processed.

### BRIEF DESCRIPTION OF THE DRAWINGS

In the following, embodiments of the present invention are explained with reference to the accompanying drawings, in which:

FIG. 1 shows a schematic representation of a construction machine, in this case an excavator, to explain embodiments;

FIG. 2 shows a schematic representation of a mobile device with a LiDAR sensor for calibration of a construction machine (here an excavator from FIG. 1) according to embodiments;

FIG. 3 shows a schematic representation of a system comprising the mobile device of FIG. 2 in networking with a cloud service and/or a construction machine controller according to embodiments; and

FIG. 4 shows a schematic representation of a mobile device with a LiDAR sensor for calibration of a construction machine (here a drill) according to embodiments.

### DETAILED DESCRIPTION OF THE INVENTION

Before the following embodiments are explained with reference to the accompanying drawings, it is pointed out that elements and structures having the same effect are provided with the same reference numerals so that the description hereof is mutually applicable or interchangeable.

In the following explanation, the invention or embodiments of the invention will be described with reference to an excavator. However, the invention is also applicable to other machines equipped with a 3D positioning and control system.

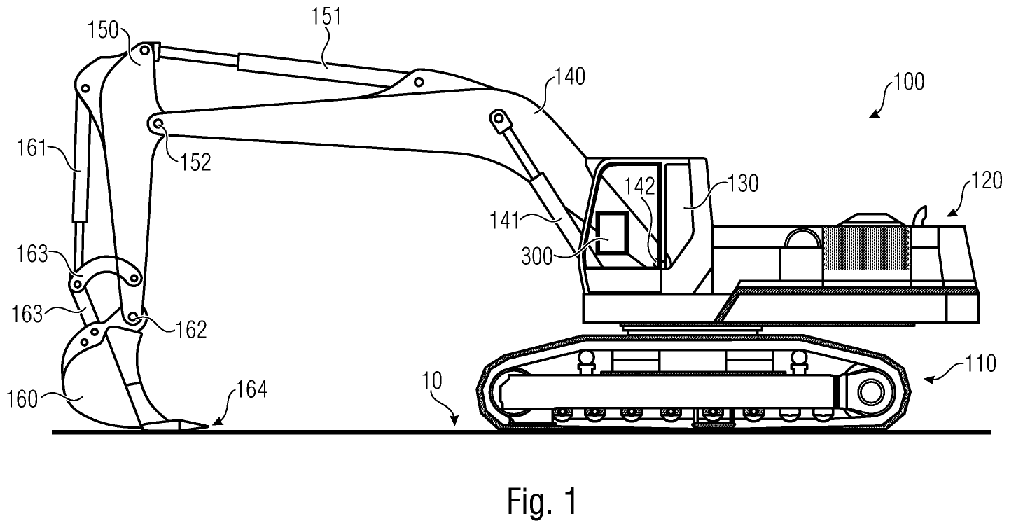

FIG. 1 shows a schematic diagram of a conventional excavator 100. This excavator 100 is used to illustrate the problems involved in calibrating. The realization of this problem is part of the invention. The excavator 100 is shown in FIG. 1 in a side view and has a lower carriage 110 and an upper carriage 120. The upper carriage 120 is rotatably connected to the lower carriage 110 via a slewing ring. The lower carriage 110 includes wheels or (as shown) caterpillar tracks for moving the excavator 100 on a surface 10. A cabin 130 is arranged on the upper carriage 120 of the excavator 100, in which an operator of the excavator 100 can sit and control the various movements of the machine 100.

The excavator 100 further includes a boom 140 pivotally attached to the upper carriage 120 at a first pivot joint 142, a dipper arm 150 pivotally attached to the boom 140 at a second pivot joint 152, and a dipper scoop 160 pivotally attached to the dipper arm 150 at a third pivot joint 162. The boom 140 and the dipper arm 150 form support members which support and position the excavator scoop 160. Hydraulic cylinders 141, 151, and 161 are actuated to cause respective relative movement of the boom 140 with respect to the upper carriage 120, of the dipper arm 150 with respect to the boom 140, and of the excavator scoop 160 with respect to the dipper arm 150. The hydraulic cylinder 161 is connected to the excavator scoop 160 via bell cranks 163. The excavator scoop 160 includes a cutting edge 164, which may include serrations.

On the boom 140, on the dipper arm 150 and on the excavator scoop 160 as well as on the upper carriage 120 of the excavator 100, further sensors such as inclination sensors and laser detectors as well as position determination devices (GNSS/GPS receivers) are usually arranged, which are used by the 3D positioning and control system (assistance system/excavator control 300). In this regard, the position determination devices (GNSS/GPS receivers) are advantageously arranged on the upper carriage 120 and serve to detect the position and orientation of the excavator 100. In order to improve the accuracy of the position determination, the position determination devices (GNSS/GPS receivers) may be configured to obtain a position signal in combination with a correction signal, e. g. a correction signal from a stationary transmitter or a geostationary transmitter, or to obtain a position signal in combination with an additional signal (e.g. from a stationary or geostationary transmitter). The inclination sensors and laser detectors can be used to determine the inclination, elevation, and position of the boom 140, dipper arm 150, and excavator scoop 160. If the excavator 100 is also equipped with a tilt rotator for slewing and rotating the excavator scoop 160, additional sensors are added to detect all possible movements of the excavator 100 and the excavator scoop 160.

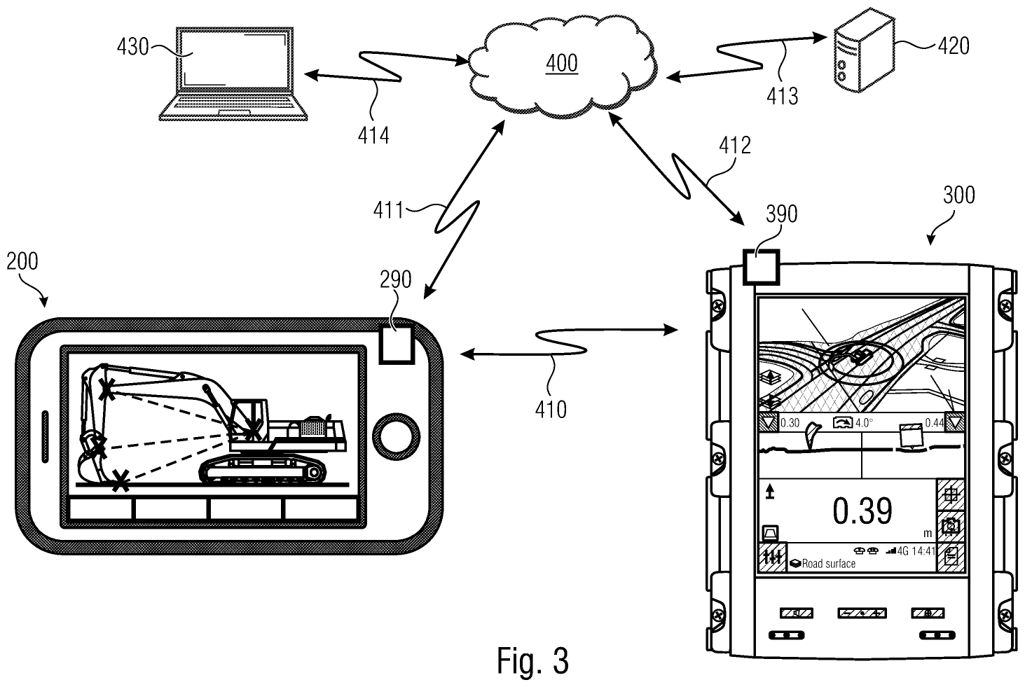

A display and operating unit of the excavator control 300 is arranged in the cabin 130, on which the exact position of the excavator scoop 160 and the excavator 100 is displayed to the operator in real time (see also FIG. 3). Apart from the display and operating unit, the excavator control 300 comprises other components not shown in the figures, such as a process computer unit (calculation unit), a memory unit, and one or more data communication interfaces 390. The process computer unit processes, for example, measurement values from sensors, detectors, and position determination devices and displays them on the graphics display of the display and operating unit of the excavator control 300. The memory unit may store data such as prefabricated 3D terrain models, which can be loaded using the process computer unit. Such a 3D model can be, for example, a terrain profile to be produced or a measurement and profile of a channel to be built or an excavation pit to be excavated. All the mentioned components, such as the display and operating unit, the process computer unit (calculation unit), the memory unit and the data communication interfaces 390 of the excavator control unit 300 are advantageously integrated in a device or in a housing to which the sensors, detectors and position determination devices are electrically connected, either wired by cable or wirelessly as radio components.

However, 3D terrain models can also be created and stored using the excavator control 300 located on the machine 100 and the associated sensors, detectors and position determination devices if the actual terrain model is not available. For this, marking points on the construction site are approached with the machine 100 and measured with the scoop 160.

In order to be able to very precisely position the excavator scoop, which is a component of the construction machine or excavator 100, the excavator 100 is calibrated accordingly before work begins. This is often done manually. Here, the measured values are transferred to the excavator control 300 in order to perform the calibration. This means that the positions of the excavator scoop 160, in particular the position of the cutting edge 164 of the excavator scoop, and of the pivot joints 142, 152 and 162 of the boom 140, the dipper arm 150 and the excavator scoop 160 must be determined and entered into the excavator control 300.

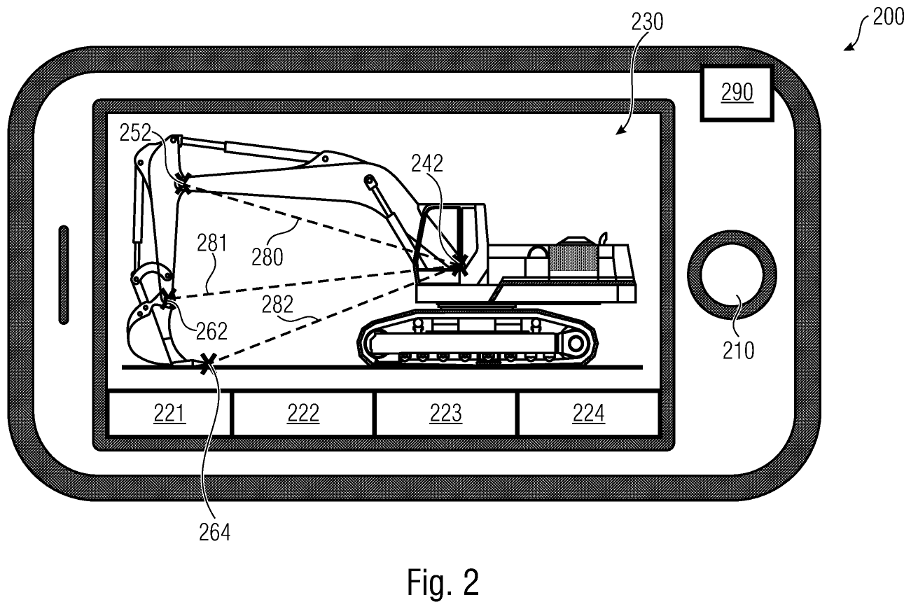

According to embodiments of the present invention, the calibration process can be improved by automated calibration. A commercially available smartphone 200 with LiDAR sensor system and a corresponding software app (3D scanner app) can be used to determine the mentioned positions as well as various dimensions and distances, for example a distance between the pivot joint of the boom 142 and the scoop tip 164 (cutting edge), as shown in FIGS. 2 and 3.

Using the smartphone 200, for example by pressing an operating button 210, an image of the excavator 100 shown in FIG. 1 is recorded in a lateral view and displayed in the display area 230, i.e. on the display of the smartphone 200. Using the LiDAR sensor system and the software app (3D scanner app), it is now possible to create a 3D model of the excavator 100, which consists of many individual points, i.e. forms a point cloud from many individual coordinates. The geometry of the excavator 100 can be precisely measured from this within a short time by further processing only the points relevant for the calibration of the excavator control 300 from all the points recorded. The 3D scanner app can be operated via the operating functions 221 to 224, i.e. various functionalities can be selected such as setting markers in the image or calculating a distance between two set markers (positions).

As shown in FIG. 2, the excavator 100 shown in the figure has markings at the following four positions: At the pivot joint of the boom 142 (marker 242), at the pivot joint of the dipper arm 152 (marker 252), at the pivot joint of the excavator scoop 162 (marker 262) and at the scoop tip (cutting edge) 164 (marker 264). Using the software app (3D Scanner App), distances between two position or marking points can now be determined in each case, for example a distance 280 between the pivot joint of the boom 142 and the pivot joint of the dipper arm 152, a distance 281 between the pivot joint of the boom 142 and the pivot joint of the excavator scoop 162, and a distance 282 between the pivot joint of the boom 142 and the scoop tip (cutting edge) 164. The software app (3D Scanner App) can be used to set even more markings in the 3D model and thus determine further distance values, for example a distance between the pivot joint of the dipper arm 152 and the dipper tip (cutting edge) 164.

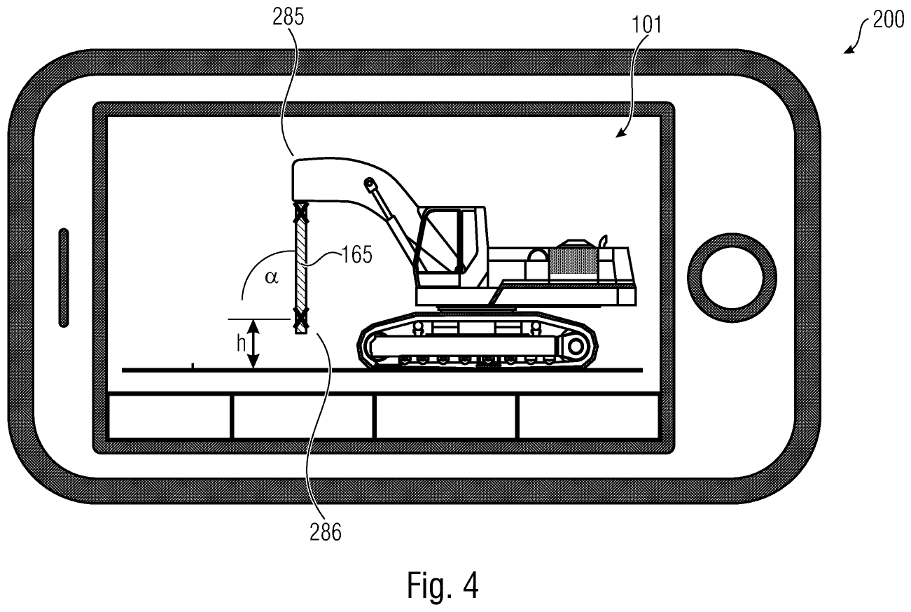

In the above embodiments, it was assumed that a complex geometry, in this case of an excavator with more than two degrees of freedom, is to be calibrated. According to embodiment examples, this complex approach can also be applied to simple machines, e.g. an earth drilling machine. A drilling machine is illustrated in FIG. 4.

FIG. 4 shows a mobile device 200 which has a LiDAR sensor, e.g., completely via the camera. By means of the camera, a construction machine 101, in this case a drilling machine 101, is recorded laterally. The drilling machine 101 has the drill 165 (corresponding component) as the tool to be calibrated. For example, two values of inclination angle α of the drill 165 and height H of the drill tip 164 (corresponding component) are entailed during startup. These can be determined based on the positions of the start and end points of the drilling tool 165. The start and end points are indicated by reference numerals 285 and 286. The height can be determined based on the position 286. The angle α can be determined using the relative end positions between the points 285 and 286.

For the determination, the construction machine 101 is recorded, e.g. from the side using the mobile device 200 or the camera of the mobile device 200. At the same time, the camera determines the distances to the points 285 and 286. Based on this information, the 3D positions of the measuring points 285 and 286 can be determined. The determination is performed by the processor, e.g. the processor of the smartphone 200. The processor is further configured to determine a 3D model of the component, in this case the drill 165, or even a 3D model of the component 161 together with the construction machine 101. This 3D model can then be transferred to the construction machine controller. The construction machine knows, for example at the time of calibration, its own sensor values or its own actuator positions as they were approached, and can thus perform a comparison between a height of the tool or position of the tool and the actuator positions. In order to be able to determine the degrees of freedom or to calibrate which 3D position of the component is obtained using which actuator control, the calibration steps can be repeated for several poses.

Thus, the operator performs the following steps. The construction machine is brought to an initial position, e.g. an estimated working position. In the next step, the construction machine is then measured by one or more LiDAR images, obtained by means of the mobile device 200. In the third step, 3D positions in space are then determined for a plurality of measurement points associated with the component of the construction machine or the construction machine. These 3D positions are then processed in a fourth step to obtain a 3D model of the component and/or the construction machine. This 3D model can then be transferred to the construction machine in a fifth step, e.g. wirelessly.

At this point, it should be noted that some steps are optional and that the order can vary.

According to embodiments, interaction between the user and the smart device can also take place during the measurement. For example, individual points, such as joints in the smart device or on the display of the smart device, can be marked in order to add further information to the 3D model. According to further embodiments, determining the 3D positions may also be guided by the software of the smart device. For example, the user may be guided in aligning the smart device to accurately measure the 3D positions using LiDAR. It is conceivable, for example, that the smart device communicates to the user that the construction machine is to be recorded from different angles.

The smartphone 200 further comprises a data communication interface 290, such as WLAN or Bluetooth or the like, to wirelessly transmit data to or receive data from other devices. For example, data from the 3D model such as marked positions or determined distance values can be transmitted wirelessly from the smartphone 200 to the excavator controller 300 via a direct data communication path 410. However, it is also conceivable that the data of the 3D model can be transmitted from the smartphone 200 via data communication paths 411, 413 and 414 and via a network 400 to a data server 420 and/or to a laptop or PC 430 for further processing or filing/storage. The data can be accessed, for example, via cloud services or the like.

The excavator controller 300 is configured to retrieve data from the data server 420 and/or store data on the data server 420 via the data communication interface 390 and via data communication paths 412 and 413 and via the network 400. The data may also be accessed in this case, for example, via cloud services or the like.

The invention is also applicable to other machines such as mobile drilling rigs/drilling machines. In such machines, which are equipped with a 3D positioning and control system, it is necessary, e.g. for blast hole drilling, to drill exactly parallel holes and to drill all holes to the same depth and at exactly the same angle. The alignment of the machine is an additional difficulty factor in the inclination alignment of the drill arm (see FIG. 4). Incorrectly placed holes can result in rock fall and an imprecise break-off edge during blasting operations. The invention is also applicable to pile drivers, pile driving equipment or pile driving devices, for example in the construction of pile foundations. Pile drivers are used, for example, for compacting soil or other construction materials, but in particular for driving piles or pile pipes or the like. Furthermore, the invention is also applicable to other special machines such as diaphragm wall cutters, which are used for the production of diaphragm walls for securing excavation pits, sealing and foundations.

Although some aspects have been described in connection with a device, it is understood that these aspects also represent a description of the corresponding method so that a block or component of a device is also to be understood as a corresponding method step or a feature of a method step. Similarly, aspects described in connection with or as a method step also constitute a description of a corresponding block or detail or feature of a corresponding device. Some or all of the method steps may be performed by (or using) a hardware apparatus, such as a microprocessor, a programmable computer, or an electronic circuit. In some embodiments, some or more of the most important method steps may be performed by such an apparatus.

A signal encoded according to the invention, such as an audio signal or a video signal or a transport current signal, may be stored on a digital storage medium or may be transmitted on a transmission medium such as a wireless transmission medium or a wired transmission medium, for example the Internet

The encoded audio signal according to the invention may be stored on a digital storage medium, or may be transmitted on a transmission medium, such as a wireless transmission medium or a wired transmission medium, such as the Internet.

Depending on particular implementation requirements, embodiments of the invention may be implemented in hardware or in software. The implementation may be performed using a digital storage medium, for example a floppy disk, a DVD, a Blu-ray disc, a CD, ROM, PROM, EPROM, EEPROM, or FLASH memory, a hard disk, or any other magnetic or optical storage medium on which electronically readable control signals are stored, which can or do interact with a programmable computer system so that the respective procedure will be performed. Therefore, the digital storage medium may be computer-readable.

Thus, some embodiments according to the invention include a data carrier having electronically readable control signals capable of interacting with a programmable computer system such that one of the methods described herein is performed.

Generally, embodiments of the present invention may be implemented as a computer program product having program code, the program code being operative to perform any of the methods when the computer program product runs on a computer.

For example, the program code may also be stored on a machine-readable carrier.

Other embodiments include the computer program for performing any of the methods described herein, wherein the computer program is stored on a machine-readable medium.

In other words, an embodiment of the inventive method is thus a computer program comprising program code for performing any of the methods described herein when the computer program runs on a computer.

Thus, another embodiment of the inventive methods is a data carrier (or digital storage medium or computer-readable medium) on which the computer program for performing any of the methods described herein is recorded. The data carrier, digital storage medium or computer-readable medium is typically tangible and/or non-transitory.

Thus, a further embodiment of the inventive method is a data stream or sequence of signals representing the computer program for performing any of the methods described herein. The data stream or sequence of signals may, for example, be configured to be transferred via a data communication link, for example via the Internet.

Another embodiment includes a processing device, such as a computer or programmable logic device, configured or adapted to perform any of the methods described herein.

Another embodiment includes a computer having installed thereon the computer program for performing any of the methods described herein.

Another embodiment according to the invention comprises a device or system configured to transmit a computer program for performing at least one of the methods described herein to a receiver. The transmission may be, for example, electronic or optical. The receiver may be, for example, a computer, mobile device, storage device, or similar device. The device or system may include, for example, a file server for transmitting the computer program to the receiver.

In some embodiments, a programmable logic device (for example, a field-programmable gate array, FPGA) may be used to perform some or all of the functionalities of the methods described herein. In some embodiments, a field-programmable gate array may interact with a microprocessor to perform any of the methods described herein. Generally, in some embodiments, the methods are performed on the part of any hardware device. This may be general-purpose hardware, such as a computer processor (CPU), or hardware specific to the method, such as an ASIC.

The devices described herein may be implemented using, for example, a hardware apparatus, or using a computer, or using a combination of a hardware apparatus and a computer.

The devices described herein, or any components of the devices described herein, may be implemented at least partly in hardware and/or in software (computer program).

For example, the methods described herein may be implemented using a hardware apparatus, or using a computer, or using a combination of a hardware apparatus and a computer.

The methods described herein, or any components of the methods described herein, may be performed at least partly by hardware and/or by software.

While this invention has been described in terms of several embodiments, there are alterations, permutations, and equivalents which will be apparent to others skilled in the art and which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. A calibration system for calibrating a component of a construction machine, in particular an excavator, a bulldozer, a grader, a drill rig, a pile driver or a diaphragm wall cutter, wherein the component comprises at least one degree of freedom, comprising:
a mobile device comprising a LiDAR sensor, wherein the LiDAR sensor is configured to detect a plurality of measurement points of the component and/or the construction machine to determine position information for the plurality of measurement points of the component and/or the construction machine;
a processor configured to determine a 3D model of the component and/or the construction machine based on the position information for the plurality of measurement points.

2. The calibration system according to claim 1, wherein the position information comprises distance information starting from the LiDAR sensor; and/or
wherein the position information comprises 3D position information in space; and/or
wherein the position information comprises 3D position information in a coordinate system defined by the LiDAR sensor.

3. The calibration system according to claim 1, wherein the 3D model comprises depth information; and/or
wherein a 3D position of each component is determined by at least two measurement points of the component.

4. The calibration system according to claim 1, wherein the LiDAR sensor is configured to detect the measurement points in a plurality of orientations of the LiDAR sensor to the component and/or construction machine; and/or
wherein detecting the plurality of measurement points is performed in one pose of the component and/or the construction machine; or wherein detecting the measurement points is performed in a plurality of poses of the component and/or the construction machine.

5. The calibration system according to claim 1, wherein the LiDAR sensor is configured to determine position information for the plurality of measurement points of a plurality of components comprising a plurality of degrees of freedom; and/or
wherein the processor is configured to determine the 3D model comprising the plurality of components.

6. The calibration system according to claim 1, wherein the mobile device is formed by a smart device, smartphone, or tablet PC.

7. The calibration system according to claim 1, wherein detecting comprises recording the component and/or the construction machine by means of a camera in the mobile device; and/or
wherein the mobile device comprises a human-machine interface via which one or more measurement points can be defined and/or marked by a user; and/or
wherein the mobile device comprises a human-machine interface configured to provide an indication to a user regarding the orientation of the LiDAR sensor.

8. The calibration system according to claim 1, wherein the LiDAR sensor is configured to determine a point cloud for the plurality of measurement points.

9. The calibration system according to claim 1, wherein the LiDAR sensor is part of a LiDAR scanner; and/or
wherein the LiDAR sensor is part of a LiDAR scanner configured to emit light in correspondence with a dot grid.

10. The calibration system according to claim 1, wherein the LiDAR sensor is configured to perform a distance measurement based on a light reflection and/or a time-of-flight measurement of a light reflection.

11. The calibration system according to claim 1, wherein the LiDAR sensor is configured to determine marked, color-coded and/or raised measurement points arranged on the construction machine or component;
wherein the plurality of measurement points are formed by specific points of the component and/or the construction machine from a group, the group comprising the following specific points:
joint
virtual pivot
fixed point
contact point of the tool.

12. The calibration system according to claim 1, the calibration system comprising an interface for wireless communication with a machine controller.

13. The calibration system according to claim 1, the calibration system comprising a machine controller and/or a machine display,
wherein the machine display is configured to calculate and/or display a position and/or positionings of the component based on one or more sensor data for monitoring one or more degrees of freedom while considering the 3D model;
wherein the machine controller is configured to calculate a position and/or positioning of the component based on one or more sensor data for monitoring one or more degrees of freedom while considering the 3D model.

14. A construction machine, in particular an excavator, bulldozer, grader, drilling rig, pile driver or diaphragm wall cutter, comprising a calibration system according to claim 1, and a machine controller.

15. A method for calibrating a component of a construction machine, in particular an excavator, a bulldozer, a grader, a drill rig, a pile driver or a diaphragm wall cutter, wherein the component comprises at least one degree of freedom, comprising:
detecting, by a LiDAR sensor of a mobile component, a plurality of measurement points of the component and/or the construction machine to determine position information for the plurality of measurement points of the component and/or the construction machine; and
determining a 3D model of the component and/or the construction machine based on the position information for the plurality of measurement points.

16. The method of claim 15, wherein detecting comprises recording the component and/or the construction machine by means of a camera of the mobile device; and/or
wherein the method comprising calculating and/or displaying a position and/or positioning of the component based on one or more sensor data for monitoring one or more degrees of freedom while considering the 3D model.

17. A non-transitory digital storage medium having a computer program stored thereon to perform a method for calibrating a component of a construction machine, in particular an excavator, a bulldozer, a grader, a drill rig, a pile driver or a diaphragm wall cutter, wherein the component comprises at least one degree of freedom, comprising:
detecting, by a LiDAR sensor of a mobile component, a plurality of measurement points of the component and/or the construction machine to determine position information for the plurality of measurement points of the component and/or the construction machine;
determining a 3D model of the component and/or the construction machine based on the position information for the plurality of measurement points,
when said computer program is run by a computer.
